(19) United States
(12) Patent Application Publication
(10) Pub. No.: US 2005/0263152 A1
(43) Pub. Date: Dec. 1, 2005

(54) Method for treating sleep apnea and snoring

(76) Inventor: Walter Fong, Laguna Beach, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/855,692

(22) Filed: May 26, 2004

(51) Int. Cl. A62B 7/00

(52) U.S. Cl. 128/200.24

(57) ABSTRACT

Isometric muscle manipulation results in a reduction in breathing airway restriction and the incidence and magnitude of sleep apnea and snoring. The method comprises exercises including, raising the tip of the tongue upward and backward in the mouth to touch the area between the hard palate and the soft palate of the mouth and then pressing the tongue upwardly, raising the flat tongue upward pressing it against the hard palate, placing the jaw in a slightly open attitude and pressing the tongue against the floor of the mouth, expanding the nasal and oral pharynx, and placing the jaw in the closed attitude and then protruding the jaw to a forward position.

### BACKGROUND OF THE INVENTION

### INCORPORATION BY REFERENCE

Applicant(s) hereby incorporate herein by reference, any and all U.S. patents and U.S. patent applications cited or referred to in this application.

1. Field of the Invention

This invention relates generally to methods for treating sleeping disorders and more particularly to a method for treating obstructive sleep apnea and snoring through the use of exercises for strengthening muscles related to air flow health.

2. Description of Related Art

Sleep apnea is a serious and potentially deadly disease affecting a significant portion of the population. However, relatively little research had been done on the cause and treatment of this illness. Apnea was first described in 1965 and characterized as a brief interruption of breathing patterns accompanied by snoring during sleep. There are varying degrees of apnea differentiated by the frequency of periodic breathing cessation episodes during sleep, and also the degree of hypoxia resulting from the related irregular breathing pattern.

When normal breathing is disrupted during sleep, an increased carbon dioxide level and a reduced oxygen level appears in the blood. The sleeping person is then suddenly aroused and gasps for air, and this is often accompanied by a loud snort. Sleep apnea has been variously described as choking, coughing, and sudden awakening with lack of breath, and usually with snoring.

An increased carbon dioxide level in the blood can cause adverse affects on the vital organs. The heart is usually caused to pump harder and at a higher rate in an effort to compensate for the lack of oxygen. Other organs, such as the kidneys and liver are suddenly confronted with increased blood flow and must adjust to cope with this change. This cycle may be repeated many times during a night's rest and often results in a general lack of proper rest and the restorative benefits thereof.

Some of the health problems associated with sleep apnea include hypertension, heart attack, stroke, irregular heart beat as well as psychogenic conditions from the loss of restful sleep.

Within the medical community a common belief as to the cause of this condition is a narrowing of the airways while sleeping. This is believed to be caused by a collapse of the tissue structures surrounding the airway. However, what tissue structures should the condition be attributed to is still not fully agreed upon. Also, there is no consensus as to why certain tissue structures close. Certainly, we know that the conformation of apnea related tissue structures vary between individuals and aging characteristics of these structures also vary greatly between individuals. Such variations may underlie the fact that apnea onset may occur even in youth as well as in the aged.

Medical treatment for sleep apnea has varied widely and much has been experimental. A person's health and age have been strong considerations as to what approach to take. Medication is often ineffective. Mechanical therapy providing for continuous positive airway pressure is the most common form of treatment. This procedure requires the patient to wear a facial mask during sleep while a constant pressure from an air blower forces air into the nasal passageway. The principle of this approach is that forced air flow tends to keep the throat from closing during sleep when muscles are relaxed. Dental appliance have been used to advantageously position the lower jaw and tongue, but have had a low success in improving milder cases of apnea.

Surgery has been used to widen the airway but has produced less than satisfactory results. For instance uvulopalatopharyngoplasty is a procedure to remove the tonsils, uvula, and a portion of the soft palate. Laser-assisted uvulopalotopharyngoplasty has been found to help in the reduction of snoring but is much less effective in reducing apnea. Somnoplasty is an investigative procedure somewhat effective in reducing the uvula and the back of the tongue using radiowaves. Tracheotomy is used on patients with severe and life-threatening apnea. In this procedure, a small opening in the trachea is made and a tube is inserted to provide a direct air vent to the lungs.

Other procedures involve psychological counseling and life style changes on patients who are overweight, and for those consuming significant amounts of alcohol and other control substances, as well as patients using sleeping pills. It is commonly believed that these substances contribute to sleep apnea. The following art defines the present state of technical approaches in the field of this invention.

Lubit, U.S. Pat. No. 3,447,534 describes a method of improving functioning soft palate tissue in preventing escape of air through the nose during speaking, which comprises positioning an expansible contractible element in the mouth adjacent to soft palate tissue, said element being adapted to press against the tissue of the soft palate and the posterior pharyngeal wall in its expanded condition and alternately expanding and contracting said element to stretch and exercise the muscles of the tissues of the soft palate and posterior pharyngeal wall.

Berry, U.S. Pat. No. 4,133,306 describes a semi-manually operated stimulus delivery mechanism incorporating various timing, measuring, counting and visual signal devices which control according to preset criteria, inflation and deflation of an air-filled oral exercise prosthesis.

Light, U.S. Pat. No. 5,213,553 describes a complemental series of handheld, tactile devices in kit form to assist in behavioral modification training techniques as well as utilizing the techiques of “resisted movement” and “successive approximation”. Each positioner device is handheld, with one portion protruding from the lips and the other portion loosely fitting on the patient's hard plate. Different shapes are introduced to the tongue and lips on each respective device. A commonalty within the interdependent positioner devices is presented by an elongated palatal base defining a convex upper surface to engage the palate, a manipulable handle projecting from the base and the respective devices are further characterized in configuration. Variations in configuration such as elongation, thickenings and apertures of the positioners involve primary modification to the palatal base and adjacent interconnection of the handle, whereby upon activation the patient may exercise his tongue and lips to achieve consonantal speech sounds, perfect swallowing techniques, and aid in mastication.

Miller, U.S. Pat. No. 5,431,610 describes a facial muscle exercise device including a mouthpiece which fits into the mouth over the lower jaw and teeth, which mouthpiece is connected via an elastic member to a handle which is pressed down by the user to create tension against the lower jaw. The lower jaw may then be exercised by up and down motion or thrusting forward and back or from side to side. Proper use of this device will cause the muscles in the face, chin and neck to become toned and conditioned, eliminating fatness below the chin and wrinkles.

Miller, U.S. Pat. No. 5,501,646 describes a jaw and neck muscle exercise apparatus, which includes a spring loaded support arm attached to a soft chin support on one end and to a chest plate on the other end. The chest plate is strapped around the chest bone/collar bone area and the back of the neck by a collar strap. The lower jaw may then be exercised by opening the mouth or lowering the entire head against the resistance of the spring. The resistance is selected to be proper for the size and strength of the user and the progress of the exercise program to date. Proper use of this device will cause the muscles of the face, chin and neck to become toned and conditioned, eliminating fatness below the chin and wrinkles, particularly exercising the hyoid, the infrahyoid and digastric muscles.

Karell, U.S. Pat. No. 5,792,067 describes an electromuscular stimulator that effects a beneficial medical purpose selected from the group consisting of mitigating snoring, mitigating obstructive sleep apnea, mitigating hypertension, dental analgesia, general analgesia, monitoring physiological conditions and facilitating the intraoral delivery of medication is disclosed. The electromuscular stimulator includes a first electrode for making electrical contact with a first anatomical structure selected from the group consisting of a hard palate, a soft palate and a pharynx; a second electrode for making electrical contact with a second anatomical structure; a control unit operably connected to the first and second electrodes; and a means for positioning the first and second electrodes relative to the first and second anatomical structures, respectively.

Shafer, U.S. Pat. No. 5,855,535 describes a compact jaw muscle exercise device that people use to strengthen and tone jaw muscles which includes a generally wedged shape body of plastic having upper and lower surfaces adapted to engage one's teeth. Holes run transversely through the body, which increases the deformability of the exercise device. The exercise device's resistance may be increased by inserting cylindrical members through the holes.

Horstel et al., U.S. Pat. No. 6,471,621 describes a method of treatment of groups of muscles in orofacial region, of the respiratory system, and of retaining and support system of a body of a patient and including providing a logopedic aid having at least one rubbed balloon and a plurality of valve mouthpieces for inflating the at least one rubbed balloon and characterized by different degrees of difficulty with which the balloon can be inflated, and treating the patient by having the patient inflate the balloon by using in succession valve mouthpieces with an ever increasing degree of difficulty.

Leelamanit et al., U.S. Pat. No. 6,484,053 describes a sequential stimulator for the treatment of dysphagic patients that incorporates a unit, which is capable of detecting a swallowing signal, from the glossal or temporalis surface electromyography (SEMG). When a swallowing signal is recognized, a trigger signal is sent to the stimulation generation unit to release high voltage stimuli sequentially to the suprahyoid muscles or the masseter muscles and the pharyngeal muscles in order to assist in the elevation of the larynx. This enables the pharyngeal lumen to open more widely so that food can pass through the patient's pharynx and into the oesophagus more easily during swallowing. Thus the sequential stimulator is a device for assisting swallowing in patients with dysphagia due to a variety of causes, for instance, brain injury, cerebrovascular accident, injury of the cervical nerves, muscles weakness, or old age. The stimulator is operative only when the patient attempts to swallow and provides a physiologic stimulus and provides a means of immediate relief of the swallowing difficulty. The device is also useful for physical therapy whereby the muscles under the chin, the masseter muscles and the pharyngeal muscles can be re-educated to contract in the normal coordinated sequence.

Arias, U.S. Pat. No. 6,524,225 describes a jaw, jowl and neck exercise kit to exercise the following muscles: masseters, temporalis, pterygoids, digastric, depressor anguli oris, depressor labii inferioris, mentalis, platysma and suprahoid muscles: mylohyioid, hyoglossus, geniiohyiod, genioglossus, Buccinator, Zygomaticus mayor, Zygomaticus minor, Risorius and Orbicularis oris non-invasively and without the use of electronics. The jaw, jowl and neck exercise kit comprises instruments that allow the user to isolate and contract the face and neck muscles. These contractions cause the aforementioned muscles to be exercised in a manner to produce efficient and fast results. The jaw, jowl and neck exercise kit is comprised of instruments designed to target different muscles and to allow the user to gradually increase resistance and to improve the effect of the exercise.

Ellis, U.S. Pat. No. 6,561,188 describes an apparatus configured to provide improved nasal breathing to persons requiring a range of respiratory based remedies ranging from opening collapsed nasal passages to treating allergic reaction to delivery of immediate dosage or controlled release medication. The apparatus includes connected nasal inserts which provide nodules to open the nasal passage and which directly align with the nasal air channel. For a preferred embodiment which provides a means to delivery of breathable gas mixtures or nasal and sinus rinse solutions, the inserts contain cannula which receive and connect to the source of the gas or rinse. For another embodiment using filtration, the inserts receive disposable filtration pacs. Sustained release of predetermined medical dosages is obtained by a further embodiment wherein the inserts receive medication inserts.

Byers, U.S. Pat. No. 6,652,275 describes an intra-oral article that is user-customized from a contoured, thermoplastic pre-form stretches and reconfigures cheek skin, thereby diminishing the appearance of cheek lines, wrinkles, folds, and depressions. After heating a pre-form to its softening point, it is pressed against the buccal surface of the gums and teeth in a posterior quadrant of the maxilla or mandible. The pre-form is removed from the mouth after hardening, which yields a customized impression on the interior surface of the pre-form. The customized article can subsequently be applied and removed as desired by the user.

Joubert et al., U.S. H1557 describes an arrangement for rewarding tongue-retraction exercise therapy performed by swallowing-impaired surgical and disease patients is disclosed. The achieved therapy includes execution of an oral sucking act (as opposed to lung originated suction) in combination with provision of a patient communicated incentive feedback signal measurement of the sucking act pressures-pressures below atmospheric pressure. The patient communication includes a visual bar graph related display and in the disclosed apparatus is provided with a plurality of four scale ranges in order to accommodate patients of varying swallowing act impairment. The achieved base of tongue strengthening exercise has been found to enable swallowing recovery in weeks in lieu of the expected months (or never) that is normally seen in severely impaired surgical or disease patients. A discussion of the swallowing act and its impairment behavior is included.

Our prior art search with abstracts described above teaches various apparatus with methods of using the apparatus for exercising to improve muscle coordination and strength for a variety of dysfunctional issues. This literature includes: a method and device for massaging the soft palate, a palatal exerciser control device, devices used to improve speech, swallowing and mastication, a facial muscle exerciser apparatus, a jaw, face and neck muscle exercise apparatus, an apparatus and method for mitigating sleep and other disorders through electromuscular stimulation, a jaw muscle exercise device, a method of treatment of groups of muscles in an oral-facial region by using an inflatable rubber balloon as a logopedic aid, a method and apparatus for treating poor laryngeal elevation disorders with sequential high voltage electrical stimulation, a maxillary occlusion muscles exerciser, cheek muscles exerciser, and a cheek and mouth muscles exerciser, a nasal breathing apparatus and methods of use, an intra-oral article for cosmetically stretching and reconfiguring cheek skin and method for customizing same, and a method for swallowing rehabilitation. However, the prior art does not teach a muscle training and conditioning technique for treating sleep apnea and snoring without the need of associated hardware, devices, or apparatus. The present invention fulfills this need and provides further related advantages as described in the following summary.

### SUMMARY OF THE INVENTION

The present invention teaches certain benefits in construction and use which give rise to the objectives described below.

In a best mode preferred embodiment of the present invention, isometric muscle manipulation results in a reduction in breathing airway restriction and in the incidence and magnitude of sleep apnea and snoring. The method comprises exercises including, raising the tip of the tongue upward and backward in the mouth to touch the area between the hard palate and the soft palate of the mouth and then pressing the tongue upwardly, pressing the tongue against the hard palate, placing the jaw in a slightly open attitude and pressing the tongue against the floor of the mouth, expanding the nasal and oral pharynx, and placing the jaw in the closed attitude and then protruding the lower jaw forwardly.

A primary objective of one embodiment of the present invention is to provide a method os exercising that yields advantages not taught by the prior art.

Another objective is to provide a method capable of reducing the incidence and degree of nocturnal snoring.

A further objective is to provide a method capable of reducing the incidence and degree of sleep apnea.

A further objective is to provide a method of reducing the incidence and degree of snoring and sleep apnea without the aid of any apparatus.

A still further objective is to provide a method of reducing the incidence and degree of snoring and sleep apnea without the need for taking action just prior to, or during sleep.

A yet further objective is to provide a method for reversing degenerative, or strengthening genetically inferior, muscle structures and tissue conformations which are contributory to snoring and, or sleep apnea.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate at least one of the best mode embodiments of the present invention. In such drawings:

FIG. 1 is a side elevational view of a portion of the human head shown in partial cutaway to expose the stylopharyngeus muscle structure on one side thereof;

FIG. 2 is an anterior view of the sphincters of the nasopharynx region particularly showing the location of the tsnsor veli palatine muscle structure; and

FIG. 3 is a posterior view of the muscle structure of the soft palate particularly showing the locations of the palatopharyngeus and the salpingopharyngeus muscle structures.

### DETAILED DESCRIPTION OF THE INVENTION

The above described drawing figures illustrate the muscle groups that are effected by the best mode embodiments of the present invention method, which is further defined in detail in the following description. Those having ordinary skill in the art may be able to make alterations and modifications in the present invention without departing from its spirit and scope. Therefore, it must be understood that the stated embodiments have been set forth only for the purposes of example and that they should not be taken as limiting the invention as defined in the following.

In one aspect of a best mode embodiment of the present invention isometric muscle manipulation results in a reduction in breathing airway restriction and has been shown by trials to lead to a reduction in the incidence and magnitude of sleep apnea and snoring. The method comprises five critical exercises for building and strengthening important muscles involved in the maintenance of the human air passage. These exercises each may be practiced alone with some therapeutic benefit, but when practiced together as an exercise group, significant benefit is possible. Such benefit will vary from individual to individual depending on muscle strength and conformation, age, sleeping position and other variables, however, it has been found that the exercised defined here are important to the maintenance of good health for most individuals. In detail, the exercises are: first, raising a tip of a tongue upward and backward in a mouth to touch an area between a hard palate and a soft palate along the roof of the mouth and then pressing the tongue upwardly for between 3 and 10 seconds while holding the jaw in a closed attitude; second, raising the relaxed tongue upward against the hard palate at the font of the mouth and then pressing the tongue against the hard palate for between 3 and 10 seconds while holding the jaw in the closed attitude; third, placing the jaw in a slightly open attitude and pressing the tongue against a floor of the mouth for between 3 and 10 seconds while holding the jaw immobile; fourth, expanding a nasal and an oral pharynx by slightly raising up the soft pallet and holding it for between 3 and 10 seconds; and, fifth, with the jaw in the closed attitude protruding the lower jaw forwardly to its forward-most position for between 3 and 10 seconds. The fourth exercise may be done in front of a mirror until its manipulation is learned. Preferably, these exercises are repeated, in sets of ten repetitions, each with appropriate rests between sets. One may do all five exercises in sequence, as a single set, repeating this set a total of ten times, or one may do ten repetitions of each single exercise with short rests between each repetition and then move on to the next exercise, staging the sequence of exercises at random or by selection. These two approaches are shown below, where numerals represent each of the five exercises.

| | |
|---|---|
| First set | 1, 2, 3, 4, 5 |
| Second set | 1, 2, 3, 4, 5 |
| Third set | 1, 2, 3, 4, 5 |
| Fourth set | 1, 2, 3, 4, 5 |
| Fifth set | 1, 2, 3, 4, 5 |
| Sixth set | 1, 2, 3, 4, 5 |
| Seventh set | 1, 2, 3, 4, 5 |
| Eighth set | 1, 2, 3, 4, 5 |
| Ninth set | 1, 2, 3, 4, 5 |
| Tenth set | 1, 2, 3, 4, 5 |
| First set | 1, 1, 1, 1, 1, 1, 1, 1, 1, 1 |
| Second set | 2, 2, 2, 2, 2, 2, 2, 2, 2, 2 |
| Third set | 3, 3, 3, 3, 3, 3, 3, 3, 3, 3 |
| Fourth set | 4, 4, 4, 4, 4, 4, 4, 4, 4, 4 |
| Fifth set | 5, 5, 5, 5, 5, 5, 5, 5, 5, 5 |

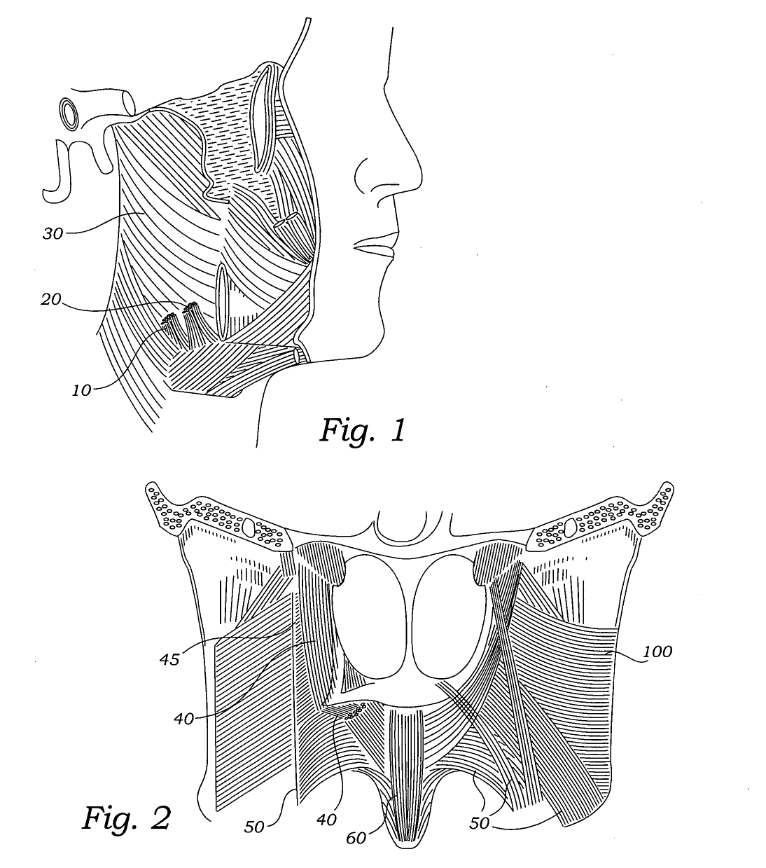

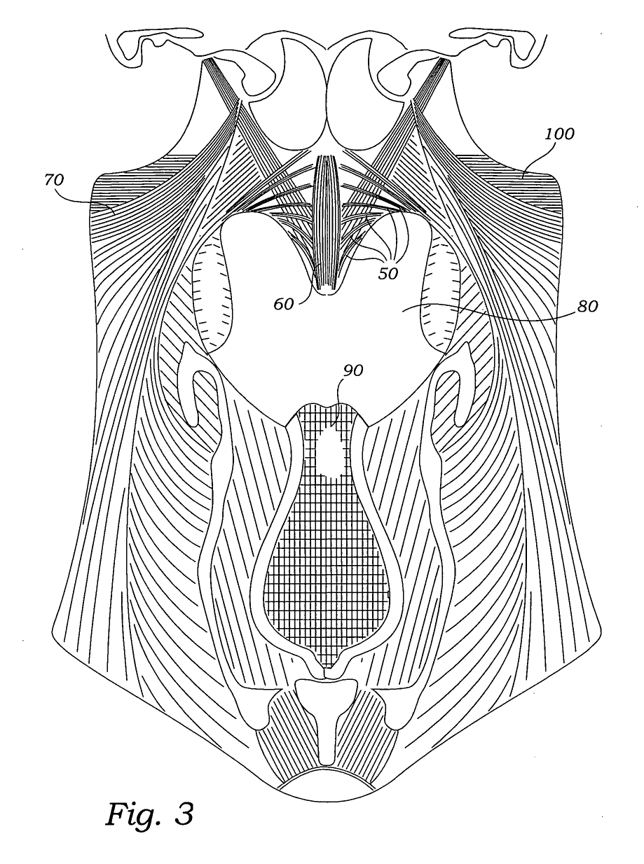

With respect to the exercises described above, certain critical muscles groups are strengthened through flexing isometrically, i.e., with the antagonistic muscles providing resistance. The muscles used include the stylopharyngeus muscles 10, as shown in FIG. 1 wherein this muscle bundle is below and slightly to the rear of the styloglossus bundle 20, and it should be noted that both the stylopharyngeus muscles 10 and the styloglossus bundle 20 lay over the superior constrictor muscles 30. The tensor veli palatine muscles 40, shown in FIG. 2, an anterior view of the sphincters of the nasopharynx, are a bundle that lays above the pharyngobasilar fascia 45. The palatopharyngeus muscles 50 are also shown in FIG. 2. The salpingopharyngeus muscles 70 are shown in FIG. 3, a posterior view of the palatopharyngeus muscle and its relations. At center of FIG. 3 is the musculus uvulae 60 and the oral pharynx 80. The palatopharyngeus muscles are shown in relation to the uvulae 60. The superior pharyngeal constrictor muscles 100 are shown here as well.

The exercising of these four muscle groups results in strengthening of these muscles and their surrounding tissues which results in improving and maintaining clearances in the human mouth and throat so as to widen and maintain a clear air passage even when sleep tends to relax all muscle tissues. The holding of isometric force against the resistance of the antagonistic muscles for between 3 and 10 seconds duration has been found to be critical to the success of the exercises and results in a balance between exercise benefit versus exercise fatigue. A person using these exercises may find that at first a 3 second isometric duration results in fatigue, but through repetition and daily workout, the duration can be made to extend for up to 10 seconds each for 10 repetitions with a few seconds of rest between repetitions. Of all possible combinations of muscle exercises of the mouth and throat muscle groups, it has been found that the present selection is superior to any other choice in bringing fast results and above all, continued improvement. Selections of less then the five described exercises have been tested with much inferior results or no improvement in chronic apnea problems. However, it has been found that the selected five exercises, when used as a unitary combination, results in great improvement with a lessening or cessation in snoring and with significant improvement in the number of apnea episodes and the duration of such episodes. Patients with heavy vibratory snoring have been brought to a level where such snoring noise is light with only the sound of the flow of air through the throat, but without pharyngeal contribution. Patients with ten to twenty breathing cessation episodes per hour of sleep have been brought to only one or two such episodes; and breathing cessation durations of from 20 to 40 seconds, have been reduces to from zero to 5 seconds. It has been found that a synergistic effect is achieved when all five of the stated exercises are performed together and it is thus this synergy and its benefit that compels the user to apply the present inventive method as one step in health improvement.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. A method of isometric muscle manipulation resulting in a reduction in breathing airway restriction leading to a reduction in the incidence and magnitude of sleep apnea and snoring, the method comprising at least one of five exercises, including:
a) raising a tip of a tongue upward and backward in a mouth to touch an area between a hard palate and a soft palate of the mouth and then pressing the tongue upwardly for a first time duration while holding the jaw in a closed attitude;
b) raising the relaxed tongue upward against the hard palate and then pressing the tongue against the hard palate for a second time duration while holding the jaw in the closed attitude;
c) placing the jaw in a slightly open attitude and pressing the tongue against a floor of the mouth for a third time duration while holding the mouth immobile;
d) expanding a nasal and an oral pharynx for a fourth time duration; and
e) placing the jaw in the closed attitude and then protruding the jaw forwardly for a fifth time duration.

2. The method of claim 1 wherein at least one of the five exercises flexes at least one of the tensor veli palatine, palatopharyngeus, stylopharyngeus and salpingopharyngeus muscles.

3. The method of claim 1 wherein each of the five exercises flexes at least one of the tensor veli palatine, palatopharyngeus, stylopharyngeus and salpingopharyngeus muscles.

4. The method of claim 1 wherein the first, second, third, fourth and fifth time durations are each between 3 and 10 seconds.

5. The method of claim 1 wherein the time duration for a single repetition of at least one of the exercises is between 3 and 10 seconds.

6. The method of claim 1 comprising repeating at least one of exercises (a) through (e) in sets with resting between sets.

7. A method of isometric muscle manipulation resulting in a reduction in breathing airway restriction leading to a reduction in the incidence and magnitude of sleep apnea and snoring, the method comprising at least two exercises practiced together, the exercises including:
a) repeating a plurality of repetitions with rests between repetitions of, the raising of a tip of a tongue upward and backward in a mouth to touch an area between a hard palate and a soft palate of the mouth and then pressing the tongue upwardly for a first time duration while holding the jaw in a closed attitude;
b) repeating a plurality of repetitions with rests between repetitions of, the raising of the tongue upward against the hard palate and then pressing the tongue against the hard palate for a second time duration while holding the jaw in the closed attitude;
c) repeating a plurality of repetitions with rests between repetitions of, the placing of the jaw in a slightly open attitude and pressing the tongue against a floor of the mouth for a third time duration while holding the mouth immobile;
d) repeating a plurality of repetitions with rests between repetitions of, the expanding of a nasal and an oral pharynx for a fourth time duration; and
e) repeating a plurality of repetitions with rests between repetitions of, the placing of the jaw in the slightly open attitude and then protruding the lower jaw forwardly for a fifth time duration.

8. The method of claim 7 wherein at least one of the exercises is accomplished by flexing at least one of the tensor veli palatine, palatopharyngeus, stylopharyngeus and salpingopharyngeus muscles.

9. The method of claim 7 wherein each of the five exercises flexes at least one of the tensor veli palatine, palatopharyngeus, stylopharyngeus and salpingopharyngeus muscles.

10. The method of claim 7 wherein the first, second, third, forth and fifth time durations are each between 3 and 10 seconds.
